(19) United States
(12) Patent Application Publication
(10) Pub. No.: US 2011/0106611 A1
(43) Pub. Date: May 5, 2011

(54) COMPLEMENTARY USER SEGMENT ANALYSIS AND RECOMMENDATION IN ONLINE ADVERTISING

(75) Inventors: Kevin L. Chang, Mountain View, CA (US); Rajesh Parekh, Mountain View, CA (US)

(73) Assignee: Yahoo! Inc., Sunnyvale, CA (US)

(21) Appl. No.: 12/612,263

(22) Filed: Nov. 4, 2009

(51) Int. Cl. G06Q 10/00; G06F 3/048; G06Q 30/00

(52) U.S. Cl. 705/14.42; 715/764

(57) ABSTRACT

The present invention provides techniques for determining user segments to increase the reach of targeted advertisements. The user segments may be determined based on factors including an advertisement category, user interest categories, and historical advertisement performance metrics associated with performance of advertisements of a relevant category in connection with various user segments. User segments may be identified that substantially increase reach while yet being anticipated to preserve, or sufficiently preserve, advertisement performance as compared with performance associated with an initially targeted user segment. Recommendations may be provided accordingly to advertisers, or automatically provided, as well as implemented, or automatically implemented.

### BACKGROUND

Online advertising has grown dramatically in recent years in magnitude and revenue. With online advertising and current sophisticated advertising networks and campaign management tools, advertisers have the ability to target advertisements to specific sets of users. Users can be targeted based on many different parameters, such as demographics, geography, and behavioral targeting, including targeting based on user interests. User targeting is a critical tool to allow online advertisers to increase their return on investment from this vital form of advertising.

Increasingly, as advertising campaigns grow in size and complexity, advertisers use campaign management tools to automate and optimize elements or aspects of their campaigns. Such tools can be of great value to advertisers, saving them time and increasing the profitability of the campaigns, and leading to greater advertiser spend and greater profit for campaign management entities, involved search engines and publishers, etc.

User targeting, however, can substantially limit the pool of users that can be reached by advertisements. Advertisers may desire to increase the reach of their advertisements, but may not know how to do so, or may need help identifying additional or expanded user segments that may substantially increase reach while preserving, or sufficiently preserving, advertisement performance relative to the smaller originally targeted group.

There is a need for techniques for use in determining user segments to increase the reach of targeted online advertisements and for making and implementing recommendations to advertisers accordingly.

### SUMMARY

Some embodiments of the invention provide techniques for determining user segments to increase the reach of targeted advertisements, considering an initial set of targeting criteria. In some embodiments, user segments may be determined based on factors including an advertisement category, and historical advertisement performance metrics associated with performance of advertisements of a relevant category in connection with various user segments. In some embodiments, user segments may be identified using user attribute or targeting information, such as demographic information, geographic or geotargeting information, information regarding user visits to a specific Web page or Web property, etc. User segments may be identified that substantially increase reach while yet being anticipated to preserve, or sufficiently preserve, advertisement performance as compared with performance associated with an initially targeted user segment. Recommendations may be provided accordingly to advertisers, or automatically provided, as well as implemented, or automatically implemented. Candidate user segments for analysis and possible recommendations may be limited based on pertinent historical advertisement performance information and pertinent user segment size information, thus reducing computational time and complexity. Biases that may be present in historical advertisement performance information may be identified and accounted for by embodiments of the invention.

### BRIEF DESCRIPTION OF THE DRAWINGS

FIG. 1 is a distributed computer system according to one embodiment of the invention;

FIG. 2 is a block diagram illustrating one embodiment of the invention;

FIG. 3 is a flow diagram of a method according to one embodiment of the invention; and

FIG. 4 is a flow diagram of a method according to one embodiment of the invention.

### DETAILED DESCRIPTION

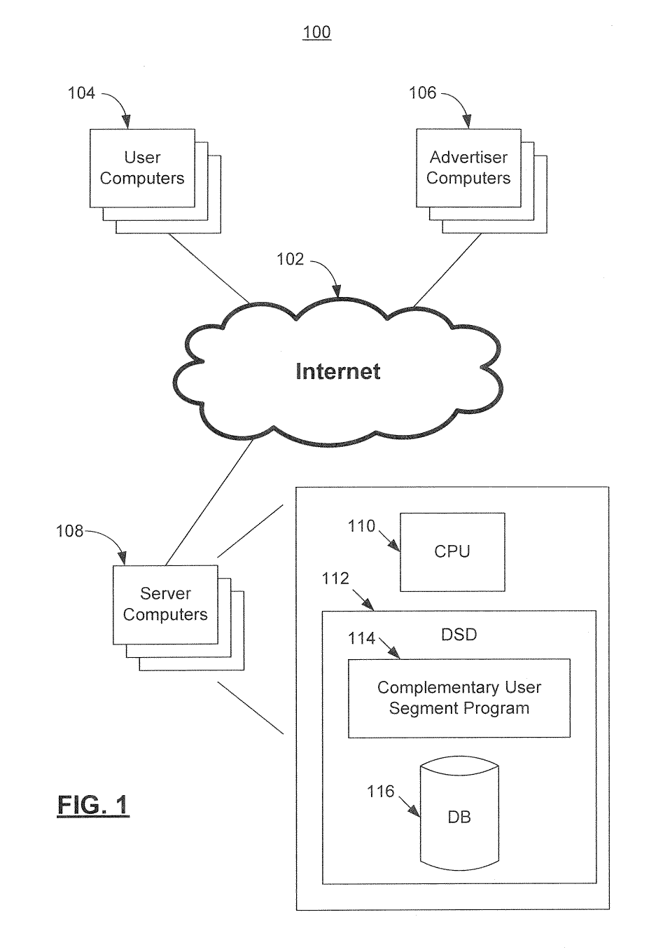

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, programs, algorithms and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as graphical or banner advertising as well as keyword searching and advertising in a sponsored search context. All types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Complementary User Segment Program 114.

The Program 114 is intended to broadly include all programming, applications, software, algorithms, and other tools necessary to implement or facilitate methods and systems according to embodiments of the invention. The elements of the Program 114 may exist on a single computer or device, or may be distributed among multiple computers or devices.

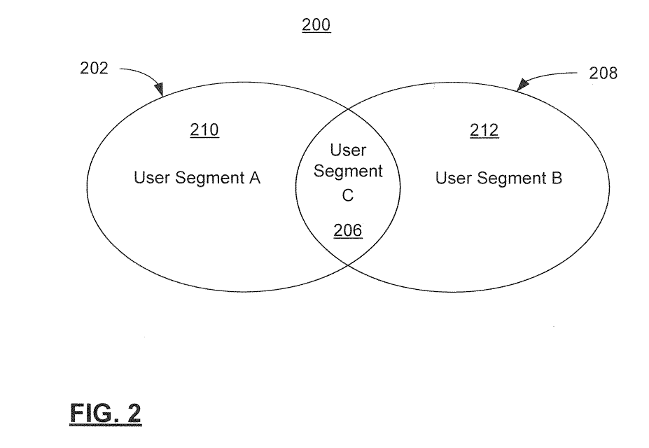

FIG. 2 is a block diagram 200 illustrating one embodiment of the invention. Some embodiments of the invention include determining and recommending user segments, for targeting of advertisements of a certain type or category. An advertiser may provide initial targeting criteria, identifying an initial targeted user segment. Techniques according to embodiments of the invention can then be used to identify one or more complementary user segments for targeting with advertisements of the certain type or category. In some embodiments, complementary user segments can be used in increasing the reach of advertisements of the type or category, when targeting is expanded to include not only the initial user segment, but also the complementary user segment.

As depicted in FIG. 2, oval 202 represents an initially targeted user segment, User Segment A. Oval 208 represents a candidate complementary user segment, User Segment B. An overlapping portion of user segments A and B, User Segment C, is represented by area 206. However, as noted elsewhere herein, in some embodiments, the overlapping portion may be empty.

In various embodiments, user segments can be delineated in different ways. In some embodiments, a user segment is defined by a category, where users that belong to the category are considered to belong to the user segment. In some embodiments, for example, a user segment may be defined as including users that belong to a particular targeting category, or particular user interest category. In some embodiments, a user segment may be defined based on specific demographic (age and gender) or geographic criteria. In some embodiments, a user segment may be defined based on a set of web sites or web pages visited by users. In some embodiments, suitable combinations of the above might be used to define user segments. In some embodiments, initial criteria are used to determine user segments that qualify as candidate complementary user segments. Analysis is then performed to determine whether particular candidate complementary user segments meet an additional set of criteria to qualify for potential or actual recommendation.

In some embodiments, one of the criteria for qualification as a candidate complementary user segment is that the user segment in question contains a portion that overlaps with an initially targeted user segment, and that the overlapping portion is of sufficient size, such as with regard to number of users. As depicted in FIG. 2, area 206 represents such an overlapping portion. However, in some embodiments, candidate user segments include segments that have small overlapping portions or no overlapping portions at all, as described further herein.

Embodiments of the invention contemplate categories of various types, such as categories that are associated with any of various types of targeting. In some embodiments, categories are topical in nature. Furthermore, in some embodiments, categories may correspond with elements or nodes of a topical or word taxonomy. For example, such a taxonomy may include nodes, which may be organized in a hierarchical structure, with some nodes being broader and including other nodes as subsets, etc.

In various embodiments, categories of different types, such as user categories and advertisement categories, may correspond with each other, or may only partially correspond, or may not correspond at all. Although corresponding categories may generally be easier to manage, non-corresponding categories, or non-corresponding taxonomies, etc., can be managed. For example, in some embodiments, partially corresponding or non-corresponding categories are mapped, partially mapped, or otherwise associated with each other.

In some embodiments, user categories are categories relating to user interests. Such interests may be determined, for example, by historical online user behavior. For example, a user who has often visited an autos site may be placed in user interest categories such as “autos”, “vehicles”, etc. Other behaviors, such as user searches, user visits of different web sites, user memberships in online social groups or organizations, etc., may be utilized. Of course, many other methods of estimating or determining user interest categories can be used.

Although various types of advertisement categories are contemplated, in some embodiments, advertisement categories correspond with user interest categories to which advertisements are targeted, or categories which high advertisement performance is anticipated.

Various types of advertisement performance parameters or metrics are contemplated by the invention, including parameters that may be configured or defined by advertisers. For example, typical performance parameters include click through rate or conversion rate.

Historical advertisement performance information, according to embodiments of the invention, can take many forms and can be gathered in many different ways. In some embodiments, utilized data can include logs of advertisement views and clicks. Data from such logs can include identification of the user, such as from a cookie or other unique identifier, advertisement view and click log data, and categorization data relating to advertisements viewed and clicked.

Other information that may be utilized includes data that maps, or allows mapping of, users to their attributes or interests. Such data may include cookie data. It may also include data regarding categories that users may be or are interested in, which can include or be known as behavioral targeting data. The data may include various demographic information regarding users, such as age, gender, etc. It may further include other types of targeting data associated with users, such as location, etc.

In some embodiments, in order for a user segment to be considered a complementary user segment, which can be recommended, the user segment must meet certain criteria. In some embodiments, some criteria are designed to require that the complementary segment be expected, anticipated, or forecasted to provide, based at least in part on historical information, performance based on the desired performance criterion, such as click through rate, that is comparable to a historical or expected performance associated with an initial targeted user segment. Generally, such performance is considered with regard to advertisements of the category of advertisements being considered. In some embodiments, this may be implemented by requiring that a candidate complementary user segment meet or exceed one or more performance or anticipated performance thresholds. In some embodiments, an advertiser may set or help set such thresholds and criteria.

In some embodiments, a complementary user segment must meet one or more criteria designed to ensure that the user segment provides at least a threshold reach, or additional reach, relative to an initial user segment. In particular, in some embodiments, to be considered a complementary user segment, a user segment must also meet certain size requirements, which can relate to the number of users in the user segment.

In some embodiments, a complementary user segment must also include a portion that overlaps with the initial targeted user segment, and that this overlapping portion is sufficiently large, such as by including at least a certain threshold number of users, or proportion of users relative to the initial targeted user segment. However, in other embodiments, overlapping portions are not required.

In addition, for a user segment to be determined to be a complementary user segment, sufficient levels of specific types of advertisement performance information of relevant types may need to be available. This may be required, for example, to allow sufficiently meaningful or statistically significant metric analysis and forecasting. For example, in some embodiments, sufficient historical advertisement performance information must be available relating to the initially targeted user segment and the candidate complementary user segment, which can include information relating to an overlapping portion as well as a non-overlapping portion of the candidate complementary user segment with the initial targeted user segment.

In some embodiments, methods or algorithms include aspects designed to manage or reduce the complexity, amount, or time involved in making determinations of complementary user segments. In some embodiments, initial criteria, such as screening criteria, may be utilized in this regard. For example, in some embodiments, complete analysis is not performed in connection with a particular initially targeted user segment, or advertisements of a particular category, unless advertisements of the particular category are actively and currently being served to users of the particular category. Another type of screening criteria can be that complete analysis is not performed in connection with a particular candidate complementary user segment unless it meets or exceeds a certain minimum size, such as a certain minimum number of users, since very small candidate segments may not substantially allow an advertiser to increase advertisement reach. In some embodiments, screening criteria can allow methods according to embodiments to be feasible, more feasible or more efficient.

In some embodiments, screening criteria can include specific reach thresholds, which can have a time element. Anticipated or forecasted performances can be based at least in part on pertinent historical performance rates. For example, thresholds can relate to an average minimum number of users in a particular user segment per a certain time period, such as per day. In some embodiments, thresholds of this type can be utilized with regard to users in an initially targeted user segment, users in a candidate complementary user segment, users in both of the foregoing user segments, and users in the candidate complementary user segment but not the initially targeted segment.

In some embodiments, candidate complementary user segments that meet initial or screening criteria, which may include size-related criteria, may then be further analyzed with respect to various performance-related metrics and criteria. Relevant metrics can include various metrics relating to historical performance of advertisements (such as click through rate, or CTR) of the pertinent category (which can be termed “Category X”) with regard to various user segments. Particular pertinent user segments and CTRs in this regard can include users in the initially targeted segment (which can be termed “User Segment A”, and “CTR_{X}(A)”), users in the candidate complementary segment (which can be termed “User Segment B” and “CTR_{X}(B)”), users in both the initially targeted segment and the candidate complementary segment (which can be termed “User Segment A+B” and “CTR_{X}(A+B)”), and users in the candidate complementary segment but not the initially targeted segment (which can be termed “User Segment B\A” and “CTR_{X}(B\A)”).

Furthermore, in some embodiments of the invention, a determined level of performance associated with serving of advertisements of the pertinent category X (in connection with an initially targeted user segment), with regard to users in the candidate complementary segment but not the initially targeted segment (as depicted as area 212 of FIG. 2) is calculated to account for bias, or is adjusted for bias. Taking into account any bias can cause or help provide a more accurate determination of the relevant level of performance. For example, a bias can be considered to exist if there exists a category (which can be termed “Category Y”), such as an interest-related category, different from a category associated with an initially targeted segment (User segment A) and different from a category associated with the candidate segment (User segment B), to which: (1) advertisements of the pertinent category (Category X) relative to the initially targeted segment; and, (2) users in the candidate complementary segment but not the initially targeted segment (User Segment B\A), both belong. User Segment B\A after excluding users to account for bias can be termed “User Segment (B\A)′”, and CTR associated with this group can be termed “CTR_{X}(B\A)′”.

In some embodiments, adjustment for bias includes the following. If Category Y is determined to exist based on the historical performance information, then performance information associated with users belonging to Category Y is excluded in determining a level of performance associated with User Segment B\A. This can have the effect of excluding performance information that may be biased due to users and the advertisements both being associated with Category Y. In a sense, if Category Y is an interest category, then it can represent a “hidden” interest of users, relative to the performance metrics being determined. Since this hidden interest can skew the data relative to the metric being determined, advertisement performance in connection with users with this hidden interest can be excluded to adjust or account for bias.

An example of a bias due to a hidden interest follows. Suppose that advertisement Category X is a sports category, and that User Segment A belongs to a sports category as well. Further suppose that User Segment B belongs to an automotive category. Further suppose that there exists another category, Category Y, which is a cable TV category. In some cases, users with a hidden interest in cable TV may click on the advertisements in the sports category (Category X) because those advertisements are also associated with a cable TV category (Category Y) This click data would then be skewed relative to the performance metric under consideration. Therefore, to adjust for bias, performance information relating to such users may be excluded.

If size or available historical performance information associated with User Segment B\A is a requirement, then, in some embodiments, size thresholds or requirements may also or instead apply to User Segment (B\A)′.

Although many possibilities are contemplated, in some embodiments, the following requirements or rules may be utilized:

Rule 1) CTR_{X}(B\A)′>θ₁ CTR_{X}(A).

Rule 2) CTR_{X}(B\A)′>θ₁ CTR_{X}(A) with significance level Z.

Rule 3) CTR_{X}(A+B)>θ₂ CTR_{X}(A).

Rule 4) The first three rules for each of at least N weeks.

Regarding the above, in some embodiments, Rule 3 may not apply if there is no overlapping portion of User Segments A and B.

In some embodiments, if all four rules are met, then a user segment can be considered a complementary user segment. In some embodiments, however, other requirements must be met as well. Such possible other requirements are generally described above, such as screening or size requirements.

Rule 1, above, requires that CTR_{X} (B\A)′ be at least a factor of θ₁ multiplied by CTR_{X}(A). In some embodiments, this can be the primary rule, since CTR_{X} (B\A)′ can be exactly the CTR of the expanded reach of the user segment to be proposed, User Segment B, relative to the initially targeted user segment, User Segment A.

Rule 2 requires that it can be determined from historical performance information with a specified level of statistical significance, level Z, that CTR_{X}(B\A)′>θ₁ CTR_{X}(A), which can provide sufficient confidence in accuracy.

Rule 3 requires that the CTR of users that are in both user segments A and B must be greater than a factor of θ₂ multiplied by CTR_{X}(A).

Rule 4 is to require that the other rules are met even over sufficiently longer time horizons.

Of course, the specific values for various parameters may be determined based on various specific factors, such as the application, etc.

In some embodiments, various parameters, such as parameters included in the above rules, can be adjusted to provide a balance, compromise, or trade-off between the size and degree of the expanded reach of a recommended segment (User segment B), on the one hand, and the quality (in terms of anticipated performance level, such as CTR) of the recommended segment, on the other.

Various embodiments of the invention contemplate various degrees of automation of the recommendation and implementation of the recommendation. In some embodiments, recommendations are automatically determined and provided, and may also be automatically implemented. Herein, the term “recommendation” is intended to broadly include, among other things, automatically determined and implemented user segment reach expansions. In some embodiments, multiple recommendations are provided to advertisers, such as through a graphical user interface, which may be interactive. In some embodiments, advertisers or their proxies can themselves alter or choose the balance and therefore modify or tune the recommendation.

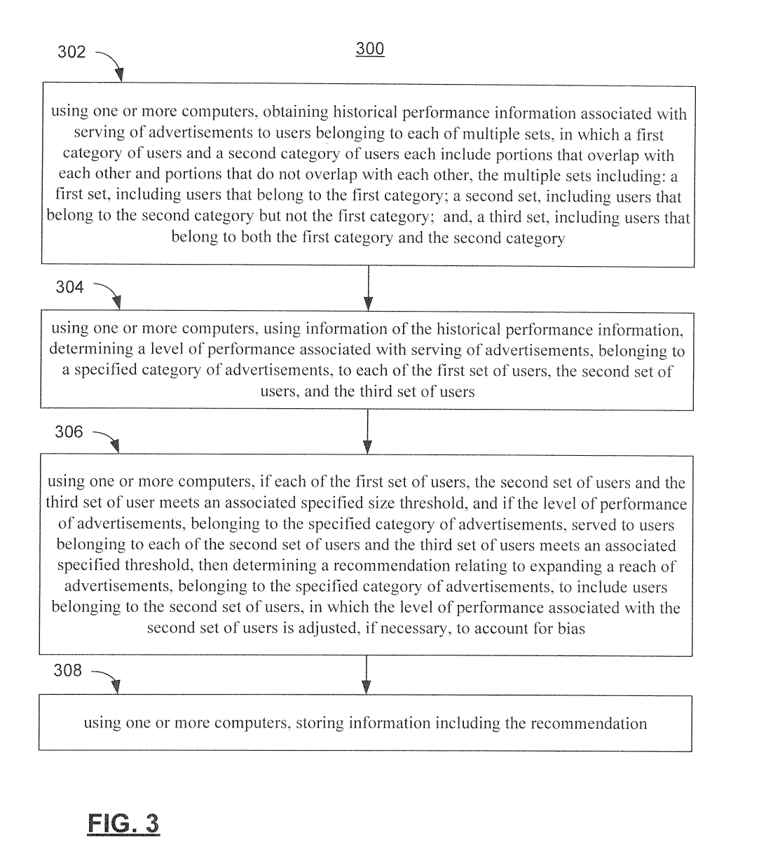

FIG. 3 is a flow diagram of a method 300 according to one embodiment of the invention. At step 302, using one or more computers, historical performance information, or performance information, is obtained that is associated with serving of advertisements to users belonging to each of multiple sets. A first category of users and a second category of users each include portions that overlap with each other and portions that do not overlap with each other. The multiple sets include: a first set, including users that belong to the first category; a second set, including users that belong to the second category but not the first category; and, a third set, including users that belong to both the first category and the second category.

At step 304, using one or more computers, using information of the historical performance information, a level of performance is determined that is associated with serving of advertisements, belonging to a specified category of advertisements, to each of the first set of users, the second set of users, and the third set of users.

At step 306, using one or more computers, if each of the first set of users, the second set of users and the third set of user meets an associated specified size threshold, and if the level of performance of advertisements, belonging to the specified category of advertisements, served to users belonging to each of the second set of users and the third set of users, meets an associated specified threshold, then determining a recommendation relating to expanding a reach of advertisements, belonging to the specified category of advertisements, to include users belonging to the second set of users. The level of performance associated with the second set of users is adjusted, if necessary, to account for bias.

It is to be noted that although embodiments of the invention are described herein largely with regard to recommendations, other applications and uses are contemplated, including automatically implemented advertising campaign management decisions or adjustments, or other uses entirely.

At step 308, using one or more computers, information is stored that includes the recommendation.

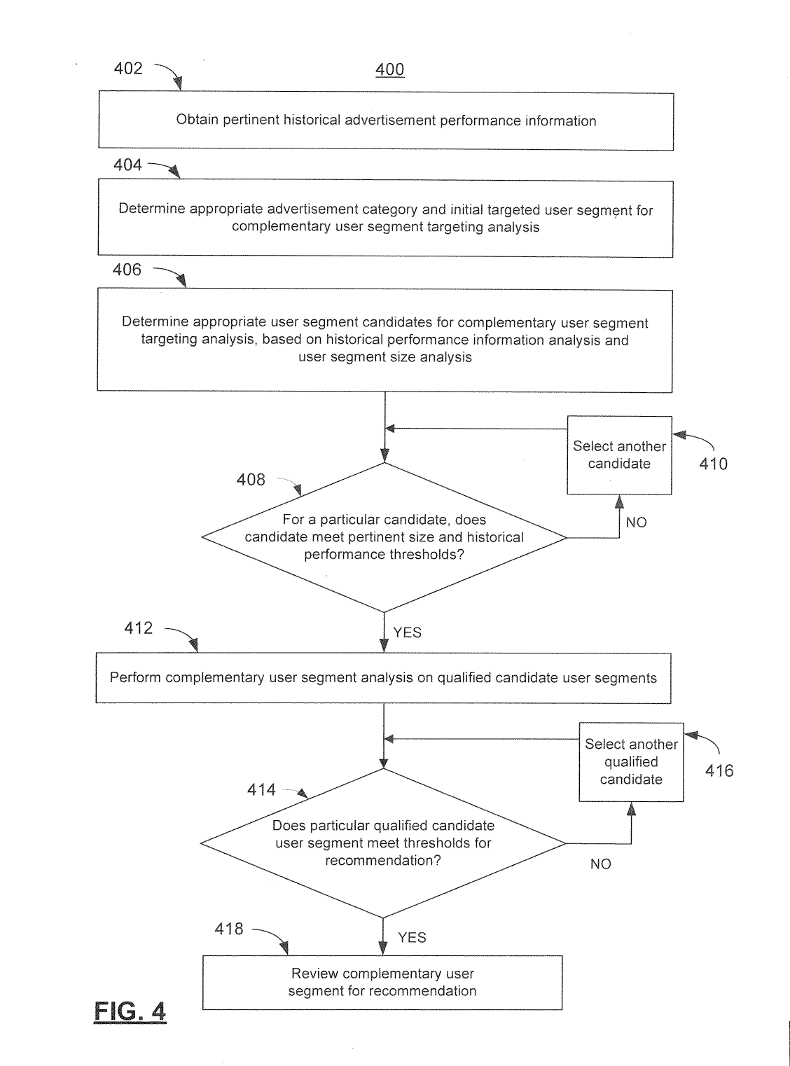

FIG. 4 is a flow diagram of a method 400 according to one embodiment of the invention. At step 402, pertinent historical advertisement performance information is obtained.

At step 404, the method 400 is used to determine an appropriate advertisement category and initial targeted user segment for complementary user segment targeting analysis.

At step 406, the method 400 is used to determine appropriate user segment candidates for complementary user segment targeting analysis, based on historical performance information analysis and user segment size analysis. In various embodiments, various criteria may be used to select user segments to analyze at step 406. For example, in some embodiments, initial selection criteria can include, among other things, a category from an apriori known taxonomy with which the user segment is associated. For example, in some embodiments, user segments may be selected that have similar or broader categorical associations relative to that of the initially targeted user segment. Another or alternative factor in user selection can be the amount of pertinent historical advertisement performance information that is available regarding the user segment.

At step 408, the method 400 queries whether, for a particular candidate, the candidate meets pertinent size and historical performance thresholds.

If “no”, then method 400 proceeds to step 410, where another candidate is selected. The method 400 then returns to step 408 with regard to another candidate.

If “yes”, then the method 400 proceeds to step 412.

At step 412, complementary user segment analysis is performed on qualified candidate user segments.

At step 414, the method 400 queries whether a particular qualified candidate user segment meets thresholds for recommendation.

If “no”, then the method 400 proceeds to step 416, at which another qualified candidate is selected, and then proceeds to step 414 with regard to that candidate.

If “yes”, then the method 400 proceeds to step 418, at which the complementary user segment is reviewed for recommendation. For example, step 418 can include use by the method 400 of any of various criteria to determine which one or more of several complementary user segments, that are recommendable, should actually be recommended.

The foregoing description is intended merely to be illustrative, and other embodiments are contemplated within the spirit of the invention.

1. A method comprising:
using one or more computers, obtaining historical performance information associated with serving of advertisements to users belonging to each of a plurality of sets, wherein a first category of users and a second category of users each comprise portions that overlap with each other and portions that do not overlap with each other, the plurality of sets comprising: a first set, comprising users that belong to the first category; a second set, comprising users that belong to the second category but not the first category; and, a third set, comprising users that belong to both the first category and the second category;
using one or more computers, using information of the historical performance information, determining a level of performance associated with serving of advertisements, belonging to a specified category of advertisements, to each of the first set of users, the second set of users, and the third set of users;
using one or more computers, if each of the first set of users, the second set of users and the third set of users meets an associated specified size threshold, and if the level of performance of advertisements, belonging to the specified category of advertisements, served to users belonging to each of the second set of users and the third set of users meets an associated specified threshold, then determining a recommendation relating to expanding a reach of advertisements, belonging to the specified category of advertisements, to include users belonging to the second set of users; and
using one or more computers, storing information comprising the recommendation.

2. The method of claim 1, wherein determining the level of performance associated with the second set of users comprises:
determining whether, based on information of the historical performance information, there is a third category, different from the first category and the second category, to which the advertisements, belonging to the specified category of advertisements, and users, belonging to the second set of users, both belong;
if it is determined that there does exist the third category, then, in the determining of the level of performance associated with advertisements, belonging to the specified category of advertisements, served to users belonging to the second act of users, excluding use of information, of the historical performance information, that relates to users, of the second set of users, that belong to the third category.

3. The method of claim 1, wherein the method comprises using the first user category and the second user category, and wherein the first category of users and the second category of users comprise user interest categories, geographic location, age, gender, information regarding visiting a specific website, or any combination thereof.

4. The method of claim 1, wherein the thresholds relating to the second set of users and the third set of users are measured relative to parameters associated with the first set of users.

5. The method of claim 1, comprising making available the recommendation to an advertiser, or a proxy of an advertiser, associated with an advertising campaign comprising advertisements belonging to the specified category of advertisements.

6. The method of claim 5, wherein making available the recommendation comprises providing a graphical user interface including the recommendation.

7. The method of claim 6, comprising, using the graphical user interface, allowing users to choose to have the recommendation automatically implemented.

8. The method of claim 1, wherein the historical performance information comprises at least one of click through rate information or conversion rate information.

9. The method of claim 1, comprising:
determining whether to select a candidate category of advertisements as the specified category of advertisements and a candidate category of users as the first category of users, for analysis using the method, based at least in part on whether advertisements of the candidate category of advertisements are actively being targeted to users of the candidate category of users in at least one advertising campaign of a set of advertising campaigns.

10. The method of claim 9, comprising:
determining whether to select a candidate first category of users as the first category of users, and a candidate second category of users as the second category of users, based at least in part on specified associated size thresholds with regard to numbers of users.

11. The method of claim 10, comprising selecting the candidate first category and the candidate second category of users based at least in part on the amount of available associated historical performance information, associated with the specified category of advertisements.

12. The method of claim 1, wherein determining a recommendation comprises determining a recommendation relating to expanding a reach of advertisements, belonging to the specified category of advertisements, from including only users in the first set of users to including users belonging to both the first set of users and the second set of users.

13. The method of claim 1, wherein the recommendation is adjustable based on advertiser-supplied criteria.

14. The method of claim 13, wherein the recommendation is adjustable based on advertiser-supplied criteria comprising targeting breadth criteria and minimum forecasted performance criteria.

15. The method of claim 1, comprising utilizing categories that are topical.

16. The method of claim 1, comprising utilizing categories that are taxonomical.

17. The method of claim 1, comprising utilizing categories, wherein categories are taxonomical, and wherein user categories correspond with advertisement categories.

18. A system comprising:
one or more server computers coupled to a network; and
one or more databases coupled to the one or more server computers;
wherein the one or more server computers are for:
obtaining historical performance information associated with serving of advertisements to users belonging to each of a plurality of sets, wherein a first category of users and a second category of users each comprise portions that overlap with each other and portions that do not overlap with each other, the plurality of sets comprising: a first set, comprising users that belong to the first category; a second set, comprising users that belong to the second category but not the first category; and, a third set, comprising users that belong to both the first category and the second category;
using information of the historical performance information, determining a level of performance associated with serving of advertisements, belonging to a specified category of advertisements, to each of the first set of users, the second set of users, and the third set of users;
if each of the first set of users, the second set of users and the third set of users meets an associated specified size threshold, and if the level of performance of advertisements, belonging to the specified category of advertisements, served to users belonging to each of the second set of users and the third set of users meets an associated specified threshold, then determining a recommendation relating to expanding a reach of advertisements, belonging to the specified category of advertisements, to include users belonging to the second set of users; and
storing information comprising the recommendation in at least one of the one or more databases.

19. The system of claim 18, wherein the network comprises the Internet.

20. A computer readable medium or media containing instructions for executing a method relating to operating an online advertising exchange, the method comprising:
using one or more computers, obtaining historical performance information associated with serving of advertisements to users belonging to each of a first set and a second set, wherein each of the first set and the second set are based on user interest categories;
using one or more computers, using information of the historical performance information, determining a level of performance associated with serving of advertisements, belonging to a specified category of advertisements, to each of the first set of users and the second set of users;
using one or more computers, if each of the first set of users and the second set of users meets an associated specified size threshold, and if the level of performance of advertisements, belonging to the specified category of advertisements, served to users belonging to the second out of users meets an associated specified threshold, then determining a recommendation relating to expanding a reach of advertisements, belonging to the specified category of advertisements, to include users belonging to the second set of users; and
using one or more computers, storing information comprising the recommendation.
